(19) United States
(12) Patent Application Publication
(10) Pub. No.: US 2018/0291679 A1
(43) Pub. Date: Oct. 11, 2018

(54) Control Device And Window Blind Using The Same

(71) Applicant: Song-Li ZHENG, Guangdong (CN)

(72) Inventor: Song-Li ZHENG, Guangdong (CN)

(21) Appl. No.: 15/977,864

(22) Filed: May 11, 2018

Related U.S. Application Data
(63) Continuation-in-part of application No. 15/482,833, filed on Apr. 10, 2017.

(51) Int. Cl. E06B 9/322; E06B 9/323

(52) U.S. Cl. CPC E06B 9/322; E06B 9/303; E06B 2009/3222; E06B 9/323

(57) ABSTRACT

A window blind system including a headrail, a bottomrail, a covering material disposed between the headrail and the bottomrail, and a control device is provided. The control device controls collection and expansion of the covering material effectively. The control device comprises a case having a first shaft and a second shaft, a coil spring, a first wheel configured with a fixing hole, a second wheel engaged with the first wheel, a torsion spring configured with a fixing end. The torsion spring is sleeved around the first shaft. The first wheel and the second wheel are pivoted in the first shaft and the second shaft. The torsion spring is disposed between the first shaft and the first wheel. The fixing end of the torsion spring is fixed in the fixing hole of the first wheel. The coil spring is winded between the first wheel and the second wheel.

This application is a continuation-in-part of application Ser. No. 15/482,833 filed on Apr. 10, 2017.

### BACKGROUND OF THE INVENTION

### Field of the Invention

The present invention relates to a control device and a window blind system using the same, and more particularly to a control device and a window blind system using the same with using safety and operating efficiency.

### Description of Related Art

The window blind is beautiful and may be adjusted freely. It may has privacy protection. Many people like to use the window blind to shading the transparent glass window. In the traditional window blind, the covering material is collected and expanded by a user manually adjusting the outer suspension cord. After the covering material is adjusted to the desired height (position), a brake mechanism or cord lock engages the outer suspension cord to hold the outer suspension cord and correspondingly the covering material in place at the desired height (position).

However, in the design of traditional window blind, the outer suspension cord is exposing outside for a certain length. As a result, children playing around can easily get caught in the outer suspension cord, and, if the children are not released immediately there-from, the outer suspension cord can accidentally strangle and hurt the children caught therein. Thus, the traditional window blind structure is quite unsafe in use and can cause danger to the family.

### SUMMARY OF THE INVENTION

Accordingly, an object of the present disclosure is to provide a control device and a window blind system using the same to improve the using safety of the window blind.

Another object of the present disclosure is to provide a control device and a window blind system using the same to control the expansion and collection speed of covering material for having a preferred operating efficiency.

To achieve the foregoing and other objects, a control device is provided. The control device is used in a window blind system. The window blind system has a headrail and a bottomrail under the headrail, wherein the bottomrail is operatively configured to ascend close to or descend away from the headrail. The control device comprises a case, a wheel assembly, and a coil spring. The case is disposed in the headrail, and has a first shaft and a second shaft. The wheel assembly has a first wheel, a second wheel and a first torsion spring. The first wheel is configured with a first fixing hole, and the first torsion spring has a first fixing end. The first torsion spring is sleeved around the first shaft, and the first wheel is pivoted in the first shaft. The first torsion spring is disposed between the first shaft and the first wheel. The first fixing end of the first torsion spring is fixed in the first fixing hole of the first wheel. The second wheel is pivoted in the second shaft and engaged with the first wheel for rotating simultaneously. The coil spring has a first end and a second end. The first end is fixed in the first wheel, and the second end is connected to the second wheel.

From above, the first wheel is engaged to the bottomrail through a connecting cord to operate simultaneously with the bottomrail. The first wheel is configured to operate for rotating when a first driving force is acting upon the first wheel, such that the bottomrail descends away from the headrail. The first wheel is configured to rotate when a second driving force is acting upon the first wheel, such that the bottomrail ascend close to the headrail. The driving direction of the first driving force is different from the driving direction of the second driving force. The second driving force comprises a recovery force from the coil spring, and the first driving force is greater than the second driving force.

Preferably, the first torsion spring coils tightly around the first shaft, a resistance force is generated between the first torsion spring and the first shaft when the first wheel rotates and the first fixing end of the first torsion spring is driven by the first wheel, the resistance force is a friction force.

Preferably, the resistance force is increased gradually when the first driving force is acting upon the first wheel and the bottomrail descends away from the headrail, the resistance force is reduced gradually when the second driving force is acting upon the first wheel and the bottomrail ascend close to the headrail, the first driving force comprises at least a weight of the bottomrail, and the bottomrail is a weight element.

Preferably, the first fixing end of the first torsion spring is driven by the rotation of the first wheel, and a deformation of the first torsion spring is generated for expanding or reducing a diameter of the first torsion spring according to the rotating direction of the first wheel.

Preferably, a maximum static friction force is provided between the first torsion spring and the first shaft, the first torsion spring rotates around the first shaft when the first driving force or the second driving force is greater than the maximum static friction force.

Preferably, the wheel assembly further comprises a sleeve, the sleeve is sleeved in the second wheel, the sleeve rotates relative to the second wheel freely, and the first wheel has a first coil spring connecting portion, the first end of the coil spring is fixed in the first coil spring connecting portion, the second end of the coil spring is winded around the sleeve.

Preferably, the first wheel has a first cord collecting portion, the second wheel has a second cord collecting portion, the connecting cord is winding to the first cord collecting portion and the second cord collecting portion respectively.

Preferably, the first wheel has a first gear, the second wheel has a second gear, the second gear is engaged with the first gear for rotating simultaneously.

Preferably, the wheel assembly further comprises a third wheel and a fourth wheel, the case further comprise a third shaft and a fourth shaft, the third wheel is pivoted in the third shaft, the fourth wheel is pivoted in the fourth shaft, the third wheel and the fourth wheel are disposed two sides of the first wheel and the second wheel, the third wheel has a third gear and a third cord collecting portion, the fourth wheel has a fourth gear and a fourth cord collecting portion, the third gear is engaged with the first gear for rotating simultaneously, the fourth gear is engaged with the second gear for rotating simultaneously, the connecting cord is winding to the third cord collecting portion and the fourth cord collecting portion respectively.

Preferably, the first torsion spring further comprise a coil body and a free end, the first fixing end and the free end are configured at two ends of the coil body, and the first fixing end is protruded from the coil body for fixing in the first fixing hole of the first wheel, the free end is extended along a winding direction of the coil body and attaches to the first shaft tightly.

To achieve the foregoing and other objects, a window blind system is further provided. The window blind system comprises a plurality of covering material, the foregoing headrail, the foregoing bottomrail, and the foregoing control device. The covering material are provided between the headrail and the bottomrail and be crossed by at least one connecting cord. The connecting cord connected to the control device also controls collection and expansion of the covering material by the foregoing wheel assembly and allows the foregoing bottomrail to descend away or ascend close to the foregoing headrail.

Preferably, the window blind system further comprising at least one direction-adjusting device disposed aside the control device, the direction-adjusting device includes a base disposed on the headrail and a resistance wheel pivoted at the base, the resistance wheel includes at least one second torsion spring configured with a second fixing end, a wheel shaft, and a wheel body configured with at least one second fixing hole, the wheel shaft is pivoted in the base, the wheel body is sleeved around the wheel shaft, the second torsion spring is disposed between the wheel shaft and the wheel body, the second fixing end of the second torsion spring is fixed in the second fixing hole of the wheel body.

### BRIEF DESCRIPTION OF THE DRAWINGS

Other features and advantages of the present disclosure will become apparent in the following detailed description of the preferred embodiments with reference to the accompanying drawings, of which:

FIG. 1 is a structural view illustrating a window blind system according to one embodiment of the present invention.

FIG. 2 is a structural view illustrating the window blind system depicted in FIG. 1 from another view.

FIG. 3 is an exploded view illustrating the control device depicted in FIG. 1.

FIG. 4 is a schematic enlarged view illustrating the first wheel, the first shaft, and the first torsion spring depicted in FIG. 3.

FIG. 5 is a top view illustrating the control device depicted in FIG. 1.

FIG. 6A is a schematic enlarged view illustrating the direction-adjusting device depicted in FIG. 1.

FIG. 6B is a schematic view illustrating the resistance wheel depicted in FIG. 6A.

FIG. 6C is an exploded view illustrating the resistance wheel depicted in FIG. 6B.

FIG. 7 is an exploded view illustrating the control device according to another embodiment of the present invention.

FIG. 8 is a schematic enlarged view illustrating the first wheel, the first shaft, and the first torsion spring depicted in FIG. 7.

### DESCRIPTION OF EMBODIMENTS

The characteristics, contents, advantages and achieved effects of the present disclosure will become more fully understood from the detailed description given herein below and the accompanying drawings which are given by way of illustration only, and thus are not limitative of the present disclosure

As required, detailed embodiments are disclosed herein. It must be understood that the disclosed embodiments are merely exemplary of and may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, material, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

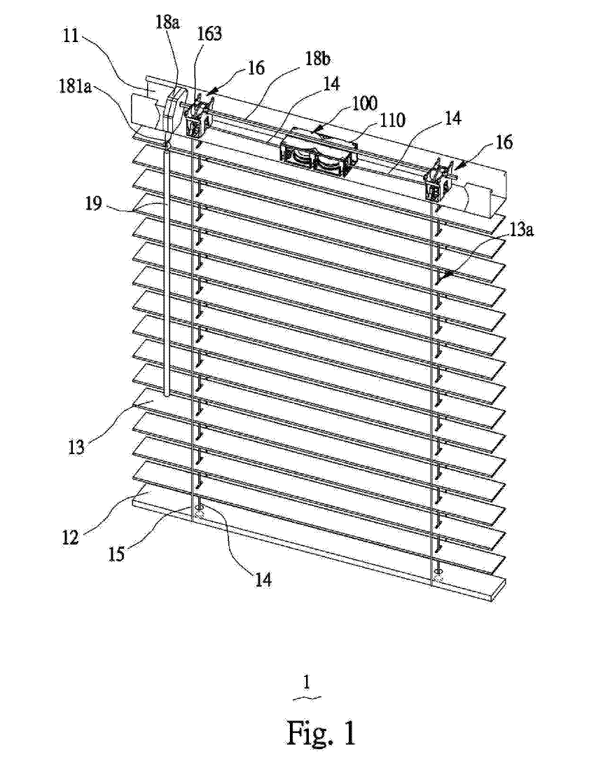

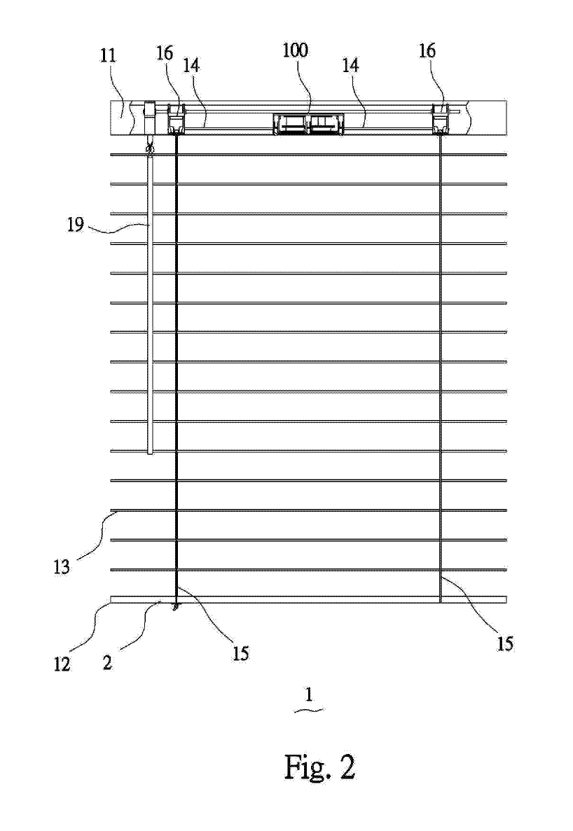

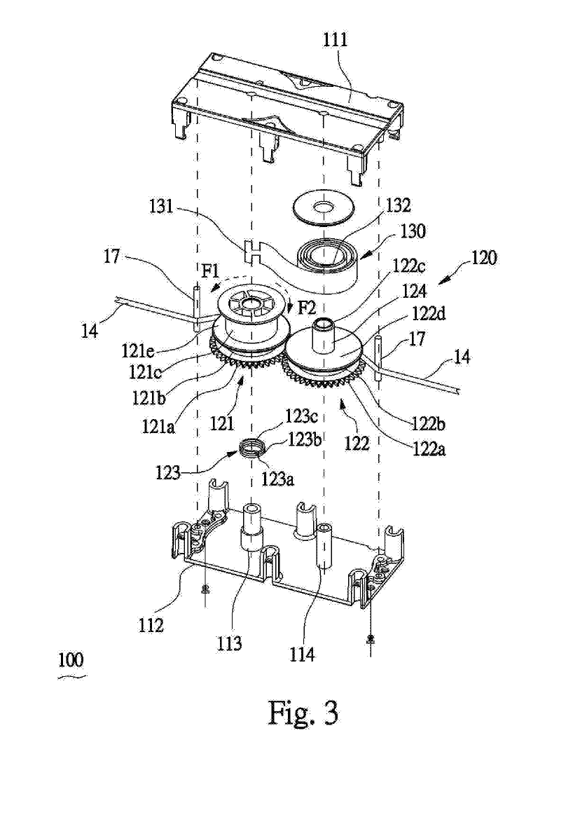

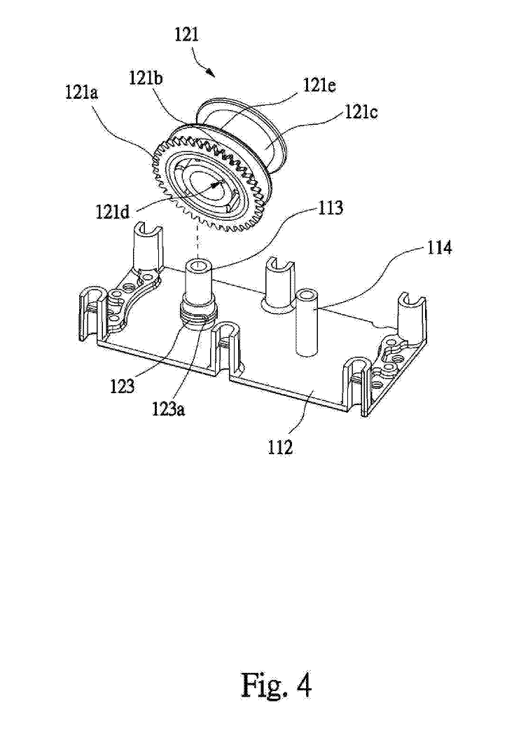

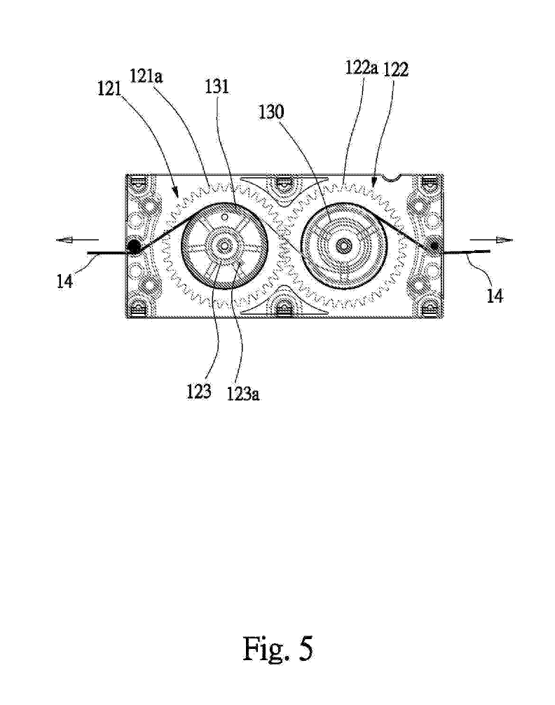

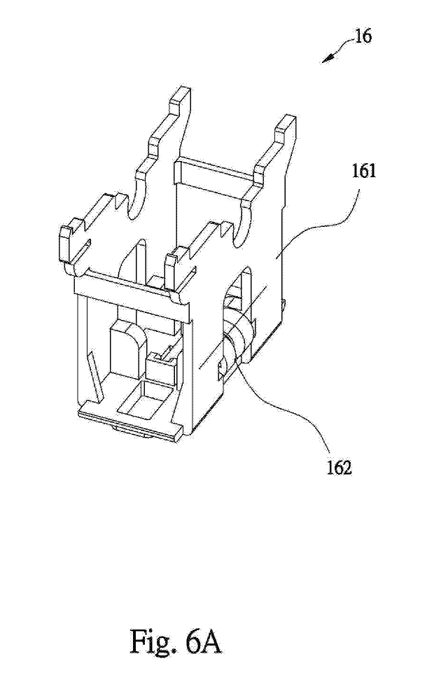

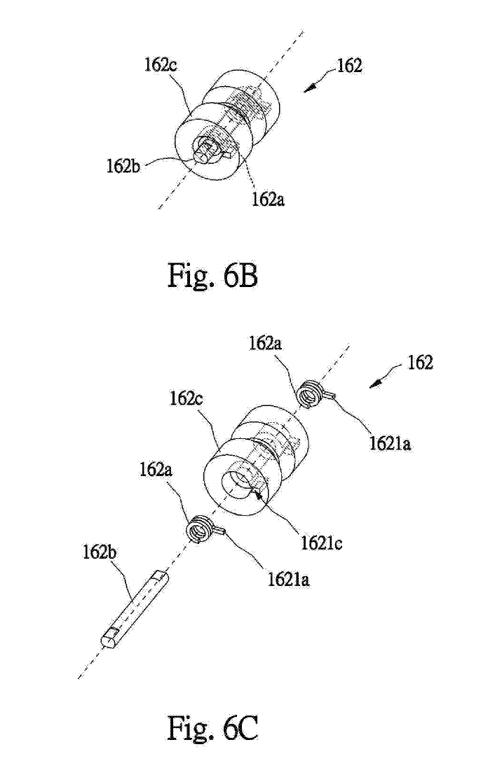

FIG. 1 is a structural view illustrating a window blind system according to one embodiment of the present invention. FIG. 2 is a structural view illustrating the window blind system depicted in FIG. 1 from another view. FIG. 3 is an exploded view illustrating the control device depicted in FIG. 1. FIG. 4 is a schematic enlarged view illustrating the first wheel, the first shaft, and the first torsion spring depicted in FIG. 3 FIG. 5 is a top view illustrating the control device depicted in FIG. 1. FIG. 6A is a schematic enlarged view illustrating the direction-adjusting device depicted in FIG. 1. FIG. 6B is a schematic view illustrating the resistance wheel depicted in FIG. 6A. FIG. 6C is an exploded view illustrating the resistance wheel depicted in FIG. 6B. Referring to FIG. 1 to FIG. 5 and FIG. 6A to FIG. 6C, in the present embodiment, a window blind system 1 comprises a control device 100, a headrail 11, a bottomrail 12 and a plurality of covering material 13 mainly. The covering material 13 can be a plurality of slats. The bottomrail 12 is, for example, a weight element.

From above, the bottomrail 12 is disposed under the headrail 11, wherein the bottomrail 12 is operatively configured to ascend close to or descend away from the headrail 11. In detail, the control device 100 is engaged to the bottomrail 12 through at least one connecting cord 14 to operate simultaneously with the bottomrail 12. There are two connecting cord 14 in the present embodiment. The connecting cord 14 also can be a pull cord. In addition, the covering material 13 is provided between the headrail 11 and the bottomrail 12 and is crossed by the connecting cord 14. The control device 100 is disposed in the headrail 11. Worth mention, the control device 100 is used to control the bottomrail 12 for ascending close to or descending away from the headrail 11. Simultaneously, the covering material 13 (window blind) can be controlled to expanded and collected by the control device 100 through the operation between the connecting cord 14 and the control device 100.

Preferably, the window blind system 1 also can comprises a ladder tape 15 and at lease one direction-adjusting device 16 disposed aside the control device 100. The ladder tape 15 is used for fixing the covering material 13 arranged below the headrail 11. The covering material 13 is fastened by the ladder tape 15 and parallel to the headrail 11. In addition, the bottomrail 12 is arranged below the covering material 13. A plurality of through holes 13a for providing each of two connecting cords 14 to pass through are respectively formed at each of the covering material 13 and the bottomrail 12. The through holes 13a of the covering material 13 and the bottomrail 12 are, for example, coaxial.

Besides, in the present embodiment, there are two direction-adjusting device 16 arranged at each of two sides of the control device 100. The two connecting cords 14 are corresponding to two direction-adjusting devices 16. One end of each of the two connecting cords 14 is connected to the control device 100, and the other end of each of the two connecting cords 14 passes through the corresponding direction-adjusting device 16 and then passes through the covering material 13 via the through holes 13a for fastening at the bottomrail 12.

In detail, each connecting cords 14 passes through the corresponding direction-adjusting device 16 along the horizontal direction, and then the connecting cords 14 pass through the through holes 13a of the covering material 13 vertically. The direction-adjusting device 16 may not only change the operating direction of the connecting cords 14, but also to a certain extent increase the friction to the connecting cords 14 to reduce the rate of sliding the connecting cords 14. Therefore, the design of the direction-adjusting device 16 also can provide suitable friction to the connecting cords 14 for enhancing the balance of the window blind system 1. Further, the direction-adjusting device 16 also can control expanding and collecting speed of the covering material 13 effectively.

In a preferred embodiment, the direction-adjusting device 16 includes, for example, a base 161 disposed on the headrail 11 and a resistance wheel 162 pivoted at the base 161. Further, the direction-adjusting device 16 can provide suitable friction between the resistance wheel 162 and the connecting cords 14 for enhancing the balance of the window blind system 1. Wherein, the resistance wheel 162 includes at least one second torsion spring 162a configured with a second fixing end 1621a, a wheel shaft 162b, and a wheel body 162c configured with a second fixing hole 1621c (as shown in FIGS. 6A-6C). The wheel shaft 162b is pivoted in the base 161. The wheel body 162c is sleeved around the wheel shaft 162b. The second torsion spring 162a is disposed between the wheel shaft 162b and the wheel body 162c. Preferably, the second torsion spring 162a coils tightly around the wheel shaft 162b.

When the wheel body 162c is sleeved around the wheel shaft 162b, the second fixing end 1621a of the second torsion spring 162a is fixed in the second fixing hole 1621c of the wheel body 162c. Thus, a resistance force can be generated between the second torsion spring 162a and the wheel shaft 162b when the resistance wheel 162 rotates and the second fixing end 1621a of the second torsion spring 162a is driven by the resistance wheel 162. Wherein, the resistance force can be a friction force.

In the design of the resistance wheel 162, when the bottomrail 12 descends away from the headrail 11 and the covering material 13 is expanded, the second torsion spring 162a will be twisted along one direction and the diameter of the second torsion spring 162a reduces gradually. Further, the resistance force between the second torsion spring 162a and the wheel shaft 162b will increase gradually and an expanding speed of the covering material 13 is reduced. Relatively, when the bottomrail 12 ascends close to the headrail 11 and the covering material 13 is collected, the second torsion spring 162a will be twisted along another direction and the diameter of the second torsion spring 162a increases gradually. Further, the resistance force between the second torsion spring 162a and the wheel shaft 162b will reduces gradually and an collecting speed of the covering material 13 is increased. That is, the operation of the covering material 13 (window blind) is more easy and convenient. Also, the resistance force between the second torsion spring 162a and the wheel shaft 162b can enhances balance of the window blind system 1.

Mainly, the control device 100 comprises a case 110, a wheel assembly 120, and a coil spring 130. Wherein, in the embodiment, the case 110 is disposed in the headrail 11. The case 110 can be composed of an upper fixing plate 111 and a lower fixing plate 112. The case 110 also has a first shaft 113 and a second shaft 114. The first shaft 113 and the second shaft 114 are, for example, disposed in the lower fixing plate 112. The wheel assembly 120 has a first wheel 121, a second wheel 122 and a first torsion spring 123. The first wheel 121 and the second wheel 122 are rotatably arranged between the upper fixing plate 111 and the lower fixing plate 112. Wherein, one end of each of the two connecting cords 14 is connected to the first wheel 121 and the second wheel 122 correspondingly. The other end of each of the two connecting cords 14 passes through the corresponding direction-adjusting device 16 (resistance wheel 162) and covering material 13 to fasten at the bottomrail 12.

In the present embodiment, the first wheel 121 is configured with a first fixing hole 121d. The first torsion spring 123 has a first fixing end 123a. Preferably, the first torsion spring 123 also comprises a coil body 123b and a free end 123c. The first fixing end 123a and the free end 123c are configured at two ends of the coil body 123b. The first fixing end 123a is protruded from the coil body 123b for fixing in the first fixing hole 121d of the first wheel 121. Wherein, the first torsion spring 123 is sleeved around the first shaft 113. In other words, the free end 123c of the first torsion spring 123 is extended along a winding direction of the coil body 123b and attaches to the first shaft 113 tightly. In addition, the first wheel 121 is pivoted in the first shaft 113. Further, the first torsion spring 123 is disposed between the first shaft 113 and the first wheel 121. The second wheel 122 is pivoted in the second shaft 114 and engaged with the first wheel 121 for rotating simultaneously. Specifically, in the present embodiment, when the first wheel 121 is pivoted in the first shaft 113, the first fixing end 123a of the first torsion spring 123 sleeved around the first shaft 113 is fixed in the first fixing hole 121d of the first wheel 121. Further, when the first wheel 121 rotates, the first torsion spring 123 will be twisted suitably through the rotation of the first wheel 121.

In addition, the first wheel 121 also can includes a first gear 121a, a first cord collecting portion 121b and a first coil spring connecting portion 121c. The second wheel 122 can includes a second gear 122a, a second cord collecting portion 122b and a second coil spring connecting portion 122c. Wherein, the connecting cords 14 are winding to the first cord collecting portion 121b and the second cord collecting portion 122b respectively. Wherein, the second gear 122a is engaged with the first gear 121a for rotating simultaneously. Further, the first gear 121a and the second gear 122a are engaged by toothed engagement to rotate simultaneously.

Besides, the coil spring 130 has a first end 131 and a second end 132. The first end 131 is fixed in the first wheel 121, such as the first coil spring connecting portion 121c. The second end 132 is connected to the second wheel 122. Further, the wheel assembly 120 can comprises a sleeve 124. The sleeve 124 is sleeved in the second wheel 122. Thus, the sleeve 124 can rotates relative to the second wheel 122 freely. In the present embodiment, the first end 131 of the coil spring 130 is fixed in the first coil spring connecting portion 121c, and the second end 132 of the coil spring 130 is winded around the sleeve 124 or the second coil spring connecting portion 122c of the second wheel 122.

In an initial state of the coil spring 130 is defined as the coil spring 130 winding around the second wheel 122 or the sleeve 124 while the bottomrail 12 being at a position closest to the headrail 11 such that the covering material 13 is fully collected. During a process of expansion of the covering material 13 from fully collected to fully expanded as shown in FIG. 1, the bottomrail 12 descends from the position closest to the headrail 11, as well as the coil spring 130 unwinds from the second wheel 122 or the sleeve 124 and winds around the first wheel 121 gradually, thereby the winding diameter of the coil spring 130 wound about the second wheel 122 or the sleeve 124 reduces. Mainly, users can adjust the expansion or collection of the covering material 13 through adjusting the position of bottomrail 12.

Specifically, in the present embodiment, the coil spring 130 has springback so as to be more labor-saving to collect (pull up) and expand (pull down) the covering material 13 (window blind). Therefore, the window blind system 1 can uses the control device 100 with the coil spring 130 to control the expansion and collection of covering material 13 (window blind) to prevent from operating many times and increase up-and-down speed suitably.

Furthermore, in a preferred embodiment, in order to be more labor-saving to collect (pull up) and expand (pull down) the covering material 13 (window blind), preferably, the coil spring 130 may be a variable-force coil spring. Preferably, the diameter of each end of the variable-force coil spring is smaller than the diameter of the middle section of the variable-force coil spring to make sure that the covering material 13 (window blind) do not move back while being collected (pulled up) and expanded (pulled down) and make more labor-saving while collecting (pulling up) and expanding (pulling down) the covering material 13 (window blind).

Specifically, the position of the covering material 13 (window blind) may be changed or kept by the springback or resilience of the coil spring 130. Because the diameter of the coil spring 130 is smaller and the springback or resilience is larger, the diameter of the middle section of the coil spring 130 which is a relative short part may be increased suitably and the diameter of each end of the coil spring 130 may be reduced relatively so as to balance and make the covering material 13 (window blind) keep firmly while being collected (pulled up) and expanded (pulled down). The diameter of the middle section of the coil spring 130 which is a relative longer part is relatively larger than the diameter of each end of the coil spring 130 so that the springback or resilience of the coil spring 130 may be reduced to achieve the effect of saving labor.

It should be noted that the diameter of the middle section of the coil spring 130 may be isometric or gradually increased. That is, the diameter of the middle section of the coil spring may only suitably larger than the diameter of each end of the coil spring 130. When the covering material 13 (window blind) is expanded (pulled down), the springback or resilience of the middle section of the coil spring 130 may be not increased but reduced gradually. When the covering material 13 (window blind) is collected (pulled up), the springback or resilience of the coil spring may be gradually increased so as to quickly collect (pull up) the covering material 13 (window blind) and prevent the covering material 13 (window blind) from dropping.

Worth mention, the first wheel 121 is engaged to the bottomrail 12 through the connecting cord 14 to operate simultaneously with the bottomrail 12. The first wheel 121 is configured to operate for rotating when a first driving force F1 is acting upon the first wheel 121, such that the bottomrail 12 descends away from the headrail 11. In other words, the first wheel 121 can be driven by a first driving force to rotate in a first direction to release the connecting cord 14 which is collected thereon, thereby the bottomrail 12 descends away from the headrail 12, as well as the covering material 13 expands. The first driving force described herein is at least a weight of the bottomrail 12 or the weight of the bottomrail 12 in combination with a weight of the covering material 13 accumulated thereon. The coil spring 130 gradually winds around the first wheel 121 as the covering material 13 expands. Wherein, the first driving force F1 also includes, for example, some force provided from users.

On the other hand, the first wheel 121 is configured to rotate when a second driving force F2 is acting upon the first wheel 121, such that the bottomrail 12 ascend close to the headrail 11, the driving direction of the first driving force F1 is different from the driving direction of the second driving force F2. In other words, when the first wheel 121 is rotated in a second direction by the second driving force F2 to collect the connecting cord 14 on the first wheel 121, thereby the bottomrail 12 ascends toward the headrail 11, as well as the covering material 13 is collected toward the headrail 11, wherein the second driving force F2 comprises a recovery force from the coil spring 130. The second driving force F2 also includes, for example, some force provided from users. It should be noted that, in one embodiment of the present disclosure, the first driving force F1 is greater than the second driving force F2 such that the weight of the bottomrail 12 is greater than the recovery force unloaded by coil spring 130. When no external force is applied to the bottomrail 12, all force acting upon the whole window blind system 1 is balanced, and therefore the bottomrail 12 can stop at any position.

In a preferred embodiment, the first torsion spring 123 coils tightly around the first shaft 113. Thus, a resistance force can be generated between the first torsion spring 123 and the first shaft 113 when the first wheel 121 rotates and the first fixing end 123a of the first torsion spring 123 is driven by the first wheel 121. Wherein, the resistance force is, for example, a friction force. Further, the resistance force can be increased gradually when the first driving force F1 is acting upon the first wheel 121 and the bottomrail 12 descends away from the headrail 11. Relatively, the resistance force can be reduced gradually when the second driving force F2 is acting upon the first wheel 121 and the bottomrail 12 ascend close to the headrail 11. Wherein, the first driving force F1 comprises, for example, at least a weight of the bottomrail 12.

Further, when the first torsion spring 123 coils tightly around the first shaft 113 and the first fixing end 123a of the first torsion spring 123 is driven by the rotation of the first wheel 121, a deformation of the first torsion spring 123 is generated for expanding or reducing a diameter of the first torsion spring 123 according to the rotating direction of the first wheel 121. In detial, when the first driving force F1 is acting upon the first wheel 121 and the bottomrail 12 descends away from the headrail 11, the first torsion spring 123 will be twisted along the first direction, and then the deformation of the first torsion spring 123 is generated for reducing the diameter of the first torsion spring 123. In other words, the resistance force between the first torsion spring 123 and the first shaft 113 will increases gradually when the bottomrail 12 descends away from the headrail 11, and then the rotating speed of the first wheel 121 slows down. Therefore, an expanding speed of the covering material 13 is also reduced. On the other hand, when the second driving force F2 is acting upon the first wheel 121 and the bottomrail 12 ascend close to the headrail 11, the first torsion spring 123 will be twisted along the second direction, and then the deformation of the first torsion spring 123 is generated for increasing the diameter of the first torsion spring 123. In other words, the resistance force between the first torsion spring 123 and the first shaft 113 will reduces gradually when the bottomrail 12 ascend close to the headrail 11, and then the rotating speed of the first wheel 121 increases. Therefore, an collecting speed of the covering material 13 is also increased.

Worth mention, preferably, a maximum static friction force is provided between the first torsion spring 123 and the first shaft 113. Therefore, when the first driving force F1 or the second driving force F2 is greater than the maximum static friction force, the first torsion spring 123 still rotates around the first shaft 113. In other words, the first torsion spring 123 can rotates relative to the first shaft 113 freely. Specially, even the first torsion spring 123 rotates relative to the first shaft 113, there still exist friction force between the first torsion spring 123 and the first shaft 113.

In detial, when the bottomrail 12 is pulled down and the covering material 13 is expanded, the connecting cords 14 fastened to the bottomrail 12 will drive the first wheel 121 and the second wheel 122 to rotate. The coil spring 130 gradually winds around the first coil spring connecting portion 121c of the first wheel 121 from the second coil spring connecting portion 122c of the second wheel 122. The covering material 13 is extended downwardly. When the pull-down force (first driving force F1) is removed, the gravity of the covering material 13, the friction between the connecting cords 14 and the direction-adjusting device 16, the friction between the first torsion spring 123 and the first shaft 113, and the resilience (recovery force) of the coil spring 130 are balanced again. The first wheel 121 and the second wheel 122 stop rotating so that the covering material 13 may stop at the position where user desires.

When the bottomrail 12 is pulled up and the covering material 13 is collected gradually, the coil spring 130 is rebounded or reset. That is, the second wheel 122 rotates reversely (opposite to the direction while the bottomrail 12 is pulled down). The coil spring 130 gradually winds around the second coil spring connecting portion 122c of the second wheel 122 or the sleeve 124 from the first coil spring connecting portion 121c of the first wheel 121. The first wheel 121 and the second wheel 122 rotate simultaneously so as to collect the covering material 13. When the pull-up force (second driving force F2) is removed, the gravity of the covering material 13, the friction between the connecting cords 14 and the direction-adjusting device 16, the friction between the first torsion spring 123 and the first shaft 113, and the resilience of the coil spring 130 are balanced again. The first wheel 121 and the second wheel 122 stop rotating so that the covering material 13 may stop at the position where user desires.

According to above descriptions, the structure of the wheels is improved and the control device is simplified so that the control device may be operated by two wheels to realize the effects of driving mechanism with lots of wheels. The structure and the driving relation are easier and hard to malfunction and further to reduce the occupied space of the control device for being suitable for the window blind system with specific sizes. Especially, it is convenient to mount the window blind system in a small space so as to make it beautiful. It may reduce cost and have better practicability.

Worth mention, whether the first torsion spring 123 or the second torsion spring 162a also can provide suitable friction to control the expanding or collecting speed of the covering material 13 (window blind) effectively. In other words, when the covering material 13 (window blind) is expanded (pulled down), the resistance force between the torsion spring (first torsion spring 123/second torsion spring 162a) and shaft (first shaft 113/wheel shaft 162b) can prevent the covering material 13 (window blind) from dropping too quickly which resulting in failure to adjusting the position of the covering material 13 (window blind) effectively. Relatively, when the covering material 13 (window blind) is collected (pulled up), the resistance force between the torsion spring(first torsion spring 123/second torsion spring 162a) and shaft (first shaft 113/wheel shaft 162b) can reduce gradually which increasing the collecting speed of the covering material 13 (window blind). That is, the torsion spring(first torsion spring 123/second torsion spring 162a) of the present disclosure can use to control the expanding or collecting speed of the covering material 13 (window blind) effectively.

It should be noted that the first wheel 121 and the second wheel 122 may exchange their positions according to the winding directions of the connecting cords 15 and the coil spring 130.

In one embodiment, the first gear 121a and the second gear 122a are formed engaging teeth circumferentially. The first gear 121a and the second gear 122a are engaged with each other by the engaging teeth so that the first wheel 121 and the second wheel 122 are forced evenly and make the window blind more stable.

In order to prevent the connecting cords 14 and the coil spring 130 from interfering with each other. In another embodiment, a first partition 121e is arranged between the first coil spring connecting portion 121c and the first cord collecting portion 121b, and a second partition 122d is arranged between the second coil spring connecting portion 122c and the second cord collecting portion 122b.

In some embodiment, for example, lots of engaging teeth (not shown) are formed circumferentially at the first partition 121e and the second partition 122d. The first wheel 121 and the second wheel 122 are also engaged with each other by the engaging teeth of the first partition 121e and the second partition 122d so as to achieve the effect of simultaneous rotation for the first wheel 121 and the second wheel 122.

In a preferred embodiment, two lead posts 17 are arranged between the upper fixing plate 111 and the lower fixing plate 112. The two lead posts 17 are respectively arranged at an outside of the first wheel 121 and an outside of the second wheel 122. The connecting cords 14 are pulled out through the lead posts 17. When the connecting cords 14 are forced or pulled, they always tightly contact the lead posts 17 to prevent the connecting cords 14 from slanting. Certainly, in a preferred embodiment, a lead wheel (not shown) can be applied to cover the lead post 17. The lead wheel can rotate relative to the lead post 17. When the connecting cord 14 is pulled, the lead wheel rotates to reduce the friction formed between the connecting cord 14 and the lead wheel.

In addition, the ends of two lines of the ladder tape 15 are respectively fixed on a roller 163 of the direction-adjusting device 16. The window blind system 1 also includes a connecting iron bar 18b and a adjusting tilter assembly 18a having a turbine shaft mechanism (not shown). The connecting iron bar 18b connects with the roller 163 and the adjusting tilter assembly 18a so that the roller 163 and the adjusting tilter assembly 18a rotate synchronously. Further, the connecting iron bar 18b and the adjusting tilter assembly 18a can be used to adjust the angle of the covering material 13 further to realize light adjusting. The ladder tape 15 may wind around the roller 163 with double-layer structure so as to make the ladder tape 15 be fixed more convenient. In order to conveniently adjust light, the adjusting tilter assembly 18a has a hook 181a. A rotation shaft 19 is arranged for cooperate with the hook 181a. While in operation, the rotation shaft 19 increases the length of the shaft of the turbine shaft mechanism and may be picked up in any angle.

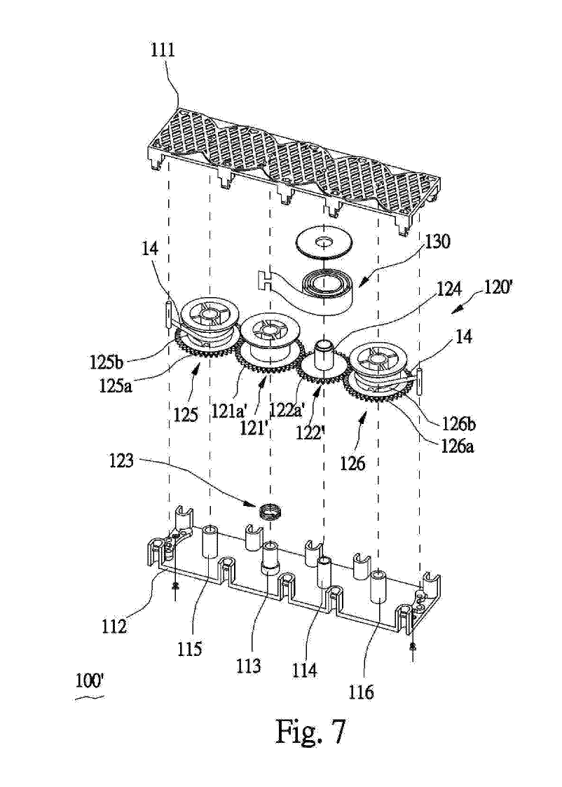

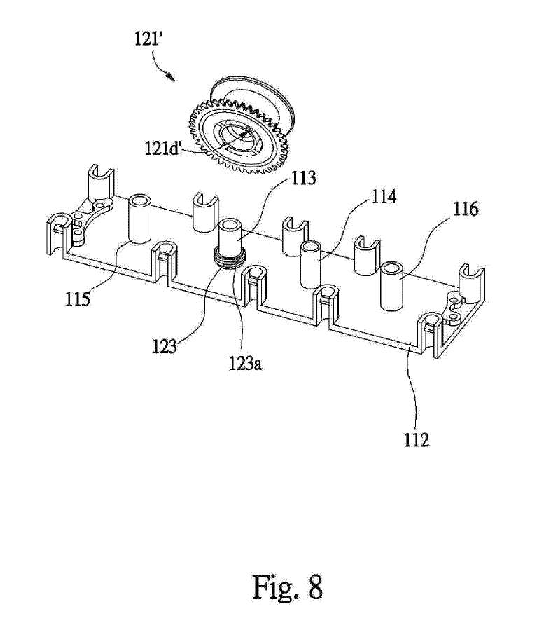

FIG. 7 is an exploded view illustrating the control device according to another embodiment of the present invention. FIG. 8 is a schematic enlarged view illustrating the first wheel, the first shaft, and the first torsion spring depicted in FIG. 7. Referring to FIG. 7 and FIG. 8, in the present embodiment, the control device 100′ is similar to the foregoing control device 100. The main difference between the control device 100′ and the foregoing control device 100 is that the wheel assembly 120′ of the control device 100′ is composed of four wheels. In detail, the wheel assembly 120′ further comprises a third wheel 125 and a fourth wheel 126. In other words, in the present embodiment, the wheel assembly 120′ of the control device 100′ includes the first wheel 121′ configured with the first fixing hole 121d′, the second wheel 122′, the third wheel 125 and the fourth wheel 126. Similarly, the wheel assembly 120′ also includes, for example, the sleeve 124 and the first torsion spring 123 configured with the first fixing end 123a. In addition, the control device 100′ also includes the coil spring 130.

Correspondingly, the case 110 further comprise a third shaft 115 and a fourth shaft 116. Thus, the third wheel 125 is pivoted in the third shaft 115, the fourth wheel 126 is pivoted in the fourth shaft 116. The third wheel 125 and the fourth wheel 126 are disposed two sides of the first wheel 121′ and the second wheel 122′. Wherein, the third wheel 125 has a third gear 125a and a third cord collecting portion 125b, and the fourth wheel 126 has a fourth gear 126a and a fourth cord collecting portion 126b. Therefore, the connecting cords 14 can wind to the third cord collecting portion 125b and the fourth cord collecting portion 126b respectively. The third gear 125a is engaged with the first gear 121a′ for rotating simultaneously, and the fourth gear 126a is engaged with the second gear 122a′ for rotating simultaneously.

Specially, in the present embodiment, the first wheel 121′ and the second wheel 122′ are just provided for being connected by the coil spring 130. The connecting cords 14 are just winded to the third wheel 125 and the fourth wheel 126 respectively. Similarly, the first wheel 121′, the second wheel 122′, the third wheel 125 and the fourth wheel 126 can be operated by the force from external users or coil spring 130 simultaneously. In short, the operation and connection between the coil spring 130 and the wheel assembly 120′ is similar to the foregoing embodiment. The operation and connection between the first wheel 121′ and first torsion spring 123 is also similar to the foregoing embodiment. Therefore, in the present embodiment, the control device 100′ also has the same functions and effectiveness like the foregoing control device 100.

To sum up, the window blind system uses the control device to control the collection and expansion of covering material to prevent from operating many times and increase collecting-and-expanding speed. Also, the window blind system uses the control device to control collecting or expanding speed of the covering material 13 through the first torsion spring or the second torsion spring effectively. Further, there is no any outer suspension cord in the present disclosure, so that the present disclosure has a preferred using safety.

It may make the two connecting cords to act synchronously and operate easily. The connecting cords pass through the covering material and the inner side of the bottomrail so as to prevent from knotting.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A control device for a window blind system, the window blind system has a headrail and a bottomrail under the headrail, wherein the bottomrail is operatively configured to ascend close to or descend away from the headrail, comprising:
a case disposed in the headrail, having a first shaft and a second shaft;
a wheel assembly, having a first wheel, a second wheel and a first torsion spring, the first wheel is configured with a first fixing hole, the first torsion spring has a first fixing end, the first torsion spring is sleeved around the first shaft and the first wheel is pivoted in the first shaft, the first torsion spring is disposed between the first shaft and the first wheel, the first fixing end of the first torsion spring is fixed in the first fixing hole of the first wheel, the second wheel is pivoted in the second shaft and engaged with the first wheel for rotating simultaneously; and
a coil spring, having a first end and a second end, the first end is fixed in the first wheel, the second end is connected to the second wheel;
wherein, the first wheel is engaged to the bottomrail through a connecting cord to operate simultaneously with the bottomrail;
wherein, the first wheel is configured to operate for rotating when a first driving force is acting upon the first wheel, such that the bottomrail descends away from the headrail;
wherein, the first wheel is configured to rotate when a second driving force is acting upon the first wheel, such that the bottomrail ascend close to the headrail, the driving direction of the first driving force is different from the driving direction of the second driving force;
wherein, the second driving force comprises a recovery force from the coil spring, and the first driving force is greater than the second driving force.

2. The control device of claim 1, wherein the first torsion spring coils tightly around the first shaft, a resistance force is generated between the first torsion spring and the first shaft when the first wheel rotates and the first fixing end of the first torsion spring is driven by the first wheel, the resistance force is a friction force.

3. The control device of claim 2, wherein the resistance force is increased gradually when the first driving force is acting upon the first wheel and the bottomrail descends away from the headrail, the resistance force is reduced gradually when the second driving force is acting upon the first wheel and the bottomrail ascend close to the headrail, the first driving force comprises at least a weight of the bottomrail, and the bottomrail is a weight element.

4. The control device of claim 2, wherein the first fixing end of the first torsion spring is driven by the rotation of the first wheel, and a deformation of the first torsion spring is generated for expanding or reducing a diameter of the first torsion spring according to the rotating direction of the first wheel.

5. The control device of claim 1, wherein a maximum static friction force is provided between the first torsion spring and the first shaft, the first torsion spring rotates around the first shaft when the first driving force or the second driving force is greater than the maximum static friction force.

6. The control device of claim 1, wherein the wheel assembly further comprises a sleeve, the sleeve is sleeved in the second wheel, the sleeve rotates relative to the second wheel freely, and the first wheel has a first coil spring connecting portion, the first end of the coil spring is fixed in the first coil spring connecting portion, the second end of the coil spring is winded around the sleeve.

7. The control device of claim 1, wherein the first wheel has a first cord collecting portion, the second wheel has a second cord collecting portion, the connecting cord is winding to the first cord collecting portion and the second cord collecting portion respectively.

8. The control device of claim 1, wherein the first wheel has a first gear, the second wheel has a second gear, the second gear is engaged with the first gear for rotating simultaneously.

9. The control device of claim 8, wherein the wheel assembly further comprises a third wheel and a fourth wheel, the case further comprise a third shaft and a fourth shaft, the third wheel is pivoted in the third shaft, the fourth wheel is pivoted in the fourth shaft, the third wheel and the fourth wheel are disposed two sides of the first wheel and the second wheel, the third wheel has a third gear and a third cord collecting portion, the fourth wheel has a fourth gear and a fourth cord collecting portion, the third gear is engaged with the first gear for rotating simultaneously, the fourth gear is engaged with the second gear for rotating simultaneously, the connecting cord is winding to the third cord collecting portion and the fourth cord collecting portion respectively.

10. The control device of claim 1, wherein the first torsion spring further comprise a coil body and a free end, the first fixing end and the free end are configured at two ends of the coil body, and the first fixing end is protruded from the coil body for fixing in the first fixing hole of the first wheel, the free end is extended along a winding direction of the coil body and attaches to the first shaft tightly.

11. A window blind system, comprising:
a headrail;
a bottomrail disposed under the headrail, wherein the bottomrail is operatively configured to ascend close to or descend away from the headrail;
a plurality of covering material, provided between the headrail and the bottomrail and be crossed by at least one connecting cord;
a control device, comprising:
a case disposed in the headrail, having a first shaft and a second shaft;
a wheel assembly, having a first wheel, a second wheel and a first torsion spring, the first wheel is configured with a first fixing hole, the first torsion spring has a first fixing end, the first torsion spring is sleeved around the first shaft and the first wheel is pivoted in the first shaft, the first torsion spring is disposed between the first shaft and the first wheel, the first fixing end of the first torsion spring is fixed in the first fixing hole of the first wheel, the second wheel is pivoted in the second shaft and engaged with the first wheel for rotating simultaneously; and
a coil spring, having a first end and a second end, the first end is fixed in the first wheel, the second end is connected to the second wheel;
wherein, the first wheel is engaged to the bottomrail through the connecting cord to operate simultaneously with the bottomrail, the connecting cord controls collection and expansion of the covering material by the wheel assembly and allows the bottomrail to descend away or ascend close to the headrail,
wherein, the first wheel is configured to operate for rotating when a first driving force is acting upon the first wheel, such that the bottomrail descends away from the headrail;
wherein, the first wheel is configured to rotate when a second driving force is acting upon the first wheel, such that the bottomrail ascend close to the headrail, the driving direction of the first driving force is different from the driving direction of the second driving force;
wherein, the second driving force comprises a recovery force from the coil spring, and the first driving force is greater than the second driving force.

12. The window blind system of claim 11, wherein the first torsion spring coils tightly around the first shaft, a resistance force is generated between the first torsion spring and the first shaft when the first wheel rotates and the first fixing end of the first torsion spring is driven by the first wheel, the resistance force is a friction force, a maximum static friction force is provided between the first torsion spring and the first shaft, the first torsion spring rotates around the first shaft when the first driving force or the second driving force is greater than the maximum static friction force.

13. The window blind system of claim 12, wherein the resistance force is increased gradually when the first driving force is acting upon the first wheel and the bottomrail descends away from the headrail, the resistance force is reduced gradually when the second driving force is acting upon the first wheel and the bottomrail ascend close to the headrail, the first driving force comprises at least a weight of the bottomrail, and the bottomrail is a weight element.

14. The window blind system of claim 12, wherein, the first fixing end of the first torsion spring is driven by the rotation of the first wheel, and a deformation of the first torsion spring is generated for expanding or reducing a diameter of the first torsion spring according to the rotating direction of the first wheel.

15. The window blind system of claim 11, further comprising at least one direction-adjusting device disposed aside the control device, the direction-adjusting device includes a base disposed on the headrail and a resistance wheel pivoted at the base, the resistance wheel includes at least one second torsion spring configured with a second fixing end, a wheel shaft, and a wheel body configured with at least one second fixing hole, the wheel shaft is pivoted in the base, the wheel body is sleeved around the wheel shaft, the second torsion spring is disposed between the wheel shaft and the wheel body, the second fixing end of the second torsion spring is fixed in the second fixing hole of the wheel body.

16. The window blind system of claim 11, wherein the wheel assembly further comprises a sleeve, the sleeve is sleeved in the second wheel, the sleeve rotates relative to the second wheel freely, and the first wheel has a first coil spring connecting portion, the first end of the coil spring is fixed in the first coil spring connecting portion, the second end of the coil spring is winded around the sleeve.

17. The window blind system of claim 11, wherein the first wheel has a first cord collecting portion, the second wheel has a second cord collecting portion, the connecting cord is winding to the first cord collecting portion and the second cord collecting portion respectively.

18. The window blind system of claim 11, wherein the first wheel has a first gear, the second wheel has a second gear, the second gear is engaged with the first gear for rotating simultaneously.

19. The window blind system of claim 18, wherein the wheel assembly further comprises a third wheel and a fourth wheel, the case further comprise a third shaft and a fourth shaft, the third wheel is pivoted in the third shaft, the fourth wheel is pivoted in the fourth shaft, the third wheel and the fourth wheel are disposed two sides of the first wheel and the second wheel, the third wheel has a third gear and a third cord collecting portion, the fourth wheel has a fourth gear and a fourth cord collecting portion, the third gear is engaged with the first gear for rotating simultaneously, the fourth gear is engaged with the second gear for rotating simultaneously, the connecting cord is winding to the third cord collecting portion and the fourth cord collecting portion respectively.

20. The window blind system of claim 11, wherein the first torsion spring further comprise a coil body and a free end, the first fixing end and the free end are configured at two ends of the coil body, and the first fixing end is protruded from the coil body for fixing in the first fixing hole of the first wheel, the free end is extended along a winding direction of the coil body and attaches to the first shaft tightly.
